(19) United States
(12) Patent Application Publication
(10) Pub. No.: US 2026/0261147 A1
(43) Pub. Date: Sep. 3, 2026

(54) MULTIFUNCTION MOBILE DEVICE MOUNT WITH ILLUMINATION, WIRELESS CHARGING, AND MULTI-SURFACE ADHESIVE ATTACHMENT

(71) Applicant: Steven Fischkin, Tampa, FL (US)

(72) Inventor: Steven Fischkin, Tampa, FL (US)

(21) Appl. No.: 19/656,364

(22) Filed: Apr. 23, 2026

Related U.S. Application Data
(63) Continuation-in-part of application No. 18/431,213, filed on Feb. 2, 2024, now Pat. No. 12,645,262.

(51) Int. Cl. H02J 50/00; F21V 33/00; G06F 1/16; H02J 50/10; H02J 50/90; F21Y 103/33

(52) U.S. Cl. CPC H02J 50/005; F21V 33/0052; G06F 1/1635; G06F 1/1656; G06F 1/1679; H02J 50/10; H02J 50/90; F21Y 2103/33

(57) ABSTRACT

A multifunction mobile device mount integrates mobile device positioning, illumination, and power delivery. The mount includes a magnetic coupling structure configured to removably couple to a mobile electronic device and a wireless charging transmitter configured to wirelessly transmit power to the mobile electronic device while coupled. The magnetic coupling structure may include a magnet array configured to align the mobile electronic device relative to the wireless charging transmitter and the light module, directly or through a compatible case, adapter plate, or magnetic ring. A light module provides illumination for imaging and may provide adjustable light intensity and adjustable color parameters including color temperature and/or RGB. A reusable adhesive attachment member is configured for releasable attachment to porous and non-porous surfaces. Wireless charging may support Qi-compatible or similar standards, and thermal management, modularity, rotational articulation, deployable supports, protective shell features, and smart connectivity may provide additional functionality and deployment modes.

### CROSS-REFERENCE TO RELATED APPLICATIONS

This application is a continuation-in-part of U.S. Patent Application No. 18/431,213, filed February 2, 2024, titled "SMART DEVICE HOLDER WITH ILLUMINATION MEANS," the entire disclosure of which is incorporated herein by reference. This application claims the benefit of the filing date of U.S. Patent Application No. 18/431,213 under 35 U.S.C. § 120 to the extent permitted by law.

### STATEMENT REGARDING FEDERALLY SPONSORED RESEARCH OR DEVELOPMENT

Not applicable.

### FIELD

The present disclosure relates to accessories for mobile electronic devices and, more particularly, to portable devices configured to mount a mobile electronic device in a hands-free manner while providing illumination and power delivery, including wireless charging, and including optional rotational articulation, modular accessory expansion, and multi-mode deployment architectures.

### BACKGROUND

Mobile electronic devices such as smartphones and tablets are widely used for photography, videography, video conferencing, livestreaming, and content creation. In many real-world settings, a user lacks a stable and convenient way to position a mobile electronic device while its camera is in use.

Users frequently improvise by leaning a phone against objects, placing the phone on unstable surfaces, or using bulkier supports such as tripods. These approaches can be inconvenient for spontaneous use, can require setup time and surface space, and can fail to provide a desired camera angle.

Lighting can further limit mobile imaging. Many environments provide inadequate illumination, and external lights can be cumbersome, require separate setup or separate power, or add bulk.

Mobile imaging and video communications can rapidly drain the phone battery. Existing mounts or lights often do not provide continuous charging during use, leading to interrupted sessions.

Some products rely on mounting strategies that are limited to smooth, non-porous surfaces. In practice, many desirable mounting surfaces, such as painted drywall, textured finishes, cabinetry, and wood, do not reliably accept such mounts, or the mount performance degrades with repeated use.

A need exists for a compact, portable device that integrates stable phone positioning, illumination, and charging, while enabling reliable mounting across a broader range of real-world surfaces, including porous and non-porous surfaces, with repeatable attachment and clean removal, and which resists design-arounds based on alternate articulation, modularity, power configurations, or mounting ecosystems.

### SUMMARY

In one embodiment, a portable multifunction device is provided that is configured to magnetically couple to a mobile electronic device, illuminate a scene using an integrated light source, and wirelessly charge the mobile electronic device while mounted.

In one embodiment, the device includes a rechargeable internal power source that powers both the light source and a wireless charging transmitter, enabling charging during imaging use without requiring a separate external power source.

In one embodiment, the device further includes a reusable, removable, multi-surface adhesive attachment member configured to releasably adhere to porous and non-porous surfaces. The adhesive attachment member may be configured to leave no residue or substantially no residue when removed.

In one embodiment, the adhesive attachment member is replaceable and is retained by a recess, slot, carrier, or cassette in a housing of the device. A pull tab, peel corner, or similar feature may facilitate removal and replacement.

In one embodiment, the device includes a deployable kickstand to support the device on a horizontal surface. In a wall-mounting mode, the adhesive attachment member supports the device on a vertical or inclined surface.

In one embodiment, the device comprises a first housing portion including a light module and a second housing portion including a power module and wireless charging transmitter, wherein the first and second housing portions are coupled by a hinge. The hinge may permit folding of the light module, including a ring or annular light module, between compact and deployed positions and may include one or more magnets to provide a snap action, detent, or stable positioning at one or more angles.

In one embodiment, the light module comprises an annular light and may include a diffuser. The light module may be controlled by an on/off input and a capacitive touch control, and may provide adjustable light intensity (brightness), such as discrete brightness levels and/or continuous dimming, and/or adjustable color temperature.

Rotational / multi-axis articulation. In one embodiment, the device further includes a rotational interface and/or multi-axis articulation interface that permits relative motion between a mounting plane (e.g., defined by the adhesive attachment member or a mounting adapter) and a device plane (e.g., defined by the magnetic coupling structure). The articulation may include 360-degree rotation, a ball joint, a swivel interface, indexed rotation, and/or a lockable friction joint, optionally independent of any hinge between housing portions.

Modular architecture. In one embodiment, the device includes a modular interface configured to removably couple one or more interchangeable modules, including interchangeable light modules, swappable battery modules, replaceable wireless charging modules, and/or snap-on accessory elements such as accessory rails, microphone mounts, diffusion/filter plates, and docking adapters.

Expanded power configurations. In one embodiment, the device supports expanded power configurations such as a detachable or swappable battery cartridge, an external battery expansion dock, dual-device charging, reverse wireless charging, adaptive multi-standard charging detection (e.g., Qi-compatible or similar inductive charging standards), and/or magnetic/alignment detection systems and magnet-array alignment systems configured to optimize wireless power transfer.

Standalone / multi-mode operation. In one embodiment, the device supports standalone operation modes including standalone lighting mode independent of phone coupling, a desk-lamp configuration, portable reading or night-light mode, emergency lighting mode, and/or power-bank functionality independent of mounting.

Tripod deployment. In one embodiment, the device includes an integrated fold-out tripod architecture (including concealed three-point support structures and/or telescoping tripod legs) and/or a detachable tripod module.

Protective / reinforcement features. In one embodiment, the housing includes protective features such as a shock-absorbing architecture, reinforced perimeter, drop-energy dispersion structures, multi-layer construction, and/or a replaceable protective shell. In one embodiment, the protective shell has a grip-enhancing geometry and/or includes a hand strap configured to improve retention during handheld use. The housing, protective shell, and structural components may be formed from polymeric, metallic, composite, elastomeric, ceramic, fiber-reinforced, and/or multi-material constructions and are not limited to any particular material selection unless expressly required by the claims.

Smart / connectivity layer. In one embodiment, the device includes a wireless communication interface (e.g., Bluetooth), a companion application, firmware update capability, gesture control, ambient light auto-adjustment, and/or coordination with mobile device imaging functions such as face-tracking.

Mounting ecosystem expansion. In one embodiment, the device supports multiple attachment ecosystems, including reusable adhesive, hybrid suction plus adhesive, a mechanical clamp attachment, a magnetic wall plate docking system, a vehicle vent adapter, and/or a permanent desk or studio docking cradle.

Expanded lighting architectures. In one embodiment, the device includes expanded lighting architectures such as RGB lighting, edge-lit panel configurations, rear-facing fill light, removable diffusion or filter plates, high-lumen professional versions, flicker-reduced ("broadcast") driver architectures, and/or thermal management features for heat generated by the light module and/or wireless charging components.

The foregoing summary is provided to introduce a selection of concepts in simplified form. Additional details are provided below in the Detailed Description. The summary is not intended to identify key features or to limit the scope of the claimed subject matter.

### BRIEF DESCRIPTION OF THE DRAWINGS

FIG. 1 is a perspective view of an embodiment of a multifunction mobile device mount shown with a mobile electronic device coupled thereto.

FIG. 2 is a front view of an embodiment of the multifunction mobile device mount.

FIG. 3 is a rear view illustrating an adhesive attachment member disposed on a rear face of a housing.

FIG. 4 is a perspective view illustrating an adhesive attachment member being peeled or removed using a peel corner or pull tab.

FIG. 5 is a perspective view of an embodiment of the multifunction mobile device mount with a kickstand in a deployed position.

FIG. 6 is a side view illustrating an embodiment including a hinge coupling a first housing portion to a second housing portion.

FIG. 7 is an exploded view illustrating an embodiment including a replaceable adhesive attachment member retained by a recess, slot, carrier, or cassette.

FIG. 8 is a perspective view illustrating an embodiment including an electrical connector for charging an internal power source and/or outputting power.

FIG. 9 is a perspective view illustrating the multifunction mobile device mount releasably attached to a vertical surface via the reusable adhesive attachment member and shown with a mobile electronic device coupled thereto, optionally with the light module activated.

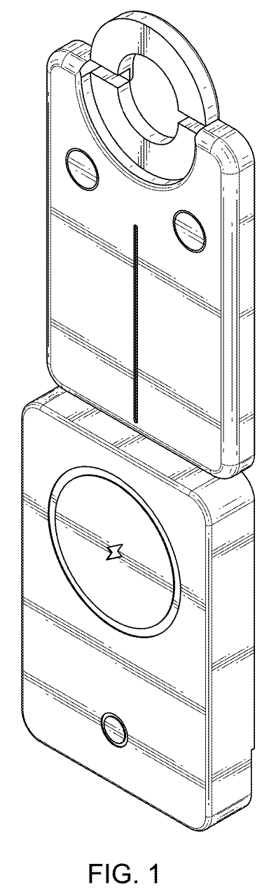

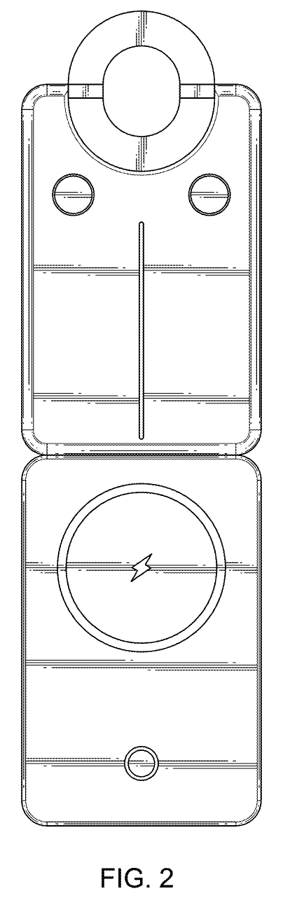

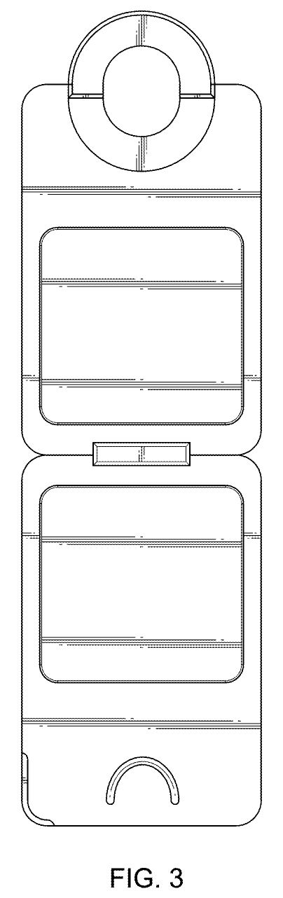

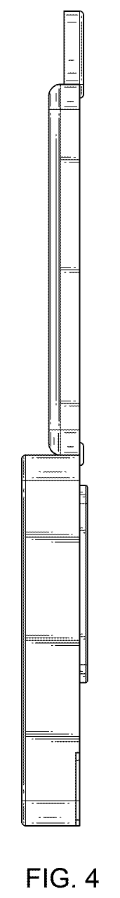

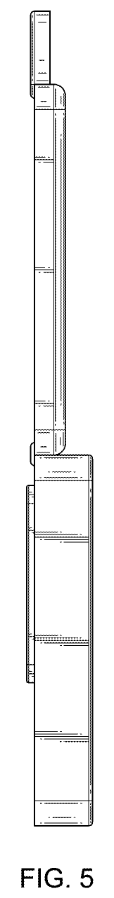

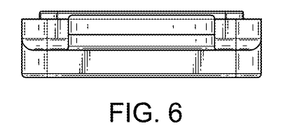

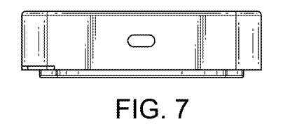

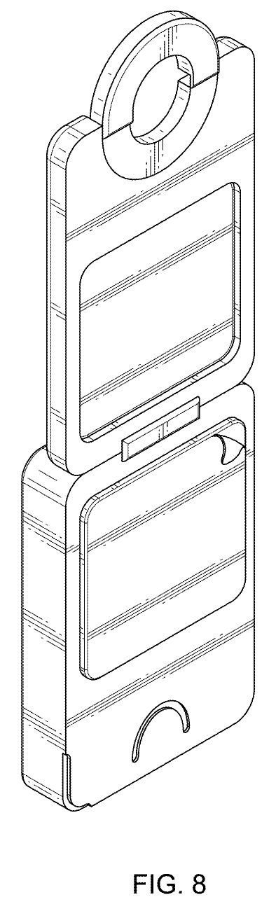

### DETAILED DESCRIPTION

The following description is presented to enable any person skilled in the art to make and use the disclosed subject matter and is provided in the context of particular embodiments and applications. Various modifications to the described embodiments will be readily apparent to those skilled in the art, and the general principles described herein may be applied to other embodiments and applications without departing from the spirit and scope of the disclosure.

As used herein, "mobile electronic device" includes a smartphone, a tablet, a mobile computer, a camera-equipped device, and similar devices. As used herein, "wireless charging" includes inductive power transfer, resonant inductive power transfer, Qi-compatible or similar inductive charging standards, magnetic alignment-assisted charging architectures, and other near-field wireless power transfer techniques.

As used herein, "porous surface" includes painted drywall, textured finishes, wood, composite materials, and other surfaces that are not smooth and non-porous. As used herein, "non-porous surface" includes glass, glazed tile, metal, mirrors, plastics, and similar surfaces.

Core multifunction platform. In one embodiment, a multifunction mobile device mount is configured to provide hands-free positioning of a mobile electronic device, illumination for imaging by the mobile electronic device, and power delivery to the mobile electronic device including wireless charging during active imaging use.

In one embodiment, the multifunction mobile device mount includes a housing comprising a front face and a rear face. The front face may include a magnetic coupling structure configured to removably couple to the mobile electronic device, directly or via a magnetically compatible case, case-mounted ring, adapter plate, magnetic ring, spacer, or similar intermediary structure. The magnetic coupling structure may comprise one or more magnets, magnet arrays, ferromagnetic elements, and/or alignment features arranged to position the mobile electronic device in a predetermined relationship relative to the wireless charging transmitter and the light module, including arrangements compatible with consumer magnetic-alignment ecosystems (e.g., MagSafe-style alignment).

In one embodiment, a wireless charging transmitter is disposed to transmit power to a wireless charging receiver of the mobile electronic device when the mobile electronic device is coupled to the front face. In one embodiment, the magnetic coupling structure, the wireless charging transmitter, and the light module are positioned relative to one another such that, when the mobile electronic device is magnetically coupled in an intended use position, the mobile electronic device is aligned both for wireless power transfer and for illumination during camera use. For example, the wireless charging transmitter may be disposed concentrically with, offset from, or otherwise in known registration with the magnetic coupling structure, and the light module may surround, flank, or otherwise be registered relative to the charging transmitter and a camera region of the mobile electronic device. In one embodiment, the mount includes a control input to enable or disable wireless charging.

Power architectures and expanded power configurations. In one embodiment, the multifunction mobile device mount includes a rechargeable internal power source such as one or more batteries. The internal power source may be disposed within a power module housing and may power the wireless charging transmitter and one or more light sources. In one embodiment, the mount includes a charging port, such as a USB-C port, to charge the internal power source. In one embodiment, the port additionally supports power output to an external device (e.g., power-bank operation).

In one embodiment, the internal power source is implemented as a removable and replaceable battery cartridge or battery module retained in a compartment of the housing by a latch, detent, sliding interface, magnetic retention, or similar retention mechanism. The battery cartridge may enable rapid swapping during extended use.

In one embodiment, the device is configured to couple to an external battery expansion dock (e.g., a base or cradle) that provides additional energy storage and/or additional connectors. The expansion dock may provide supplemental power to the device and/or may charge the internal power source.

In one embodiment, the device supports dual-device charging (e.g., charging the coupled mobile electronic device while outputting power via the port to a second device) and/or reverse wireless charging (e.g., using stored energy to wirelessly transmit power to a second device positioned on the transmitter or a secondary coil).

In one embodiment, a controller is configured to implement adaptive charging control, including detection of wireless charging standards or profiles (e.g., Qi-compatible or similar inductive charging protocols), negotiation of charging power levels when applicable, and/or enabling/disabling charging based on detected conditions, including misalignment or the presence of an intervening case, adapter plate, or magnetic ring. In one embodiment, one or more alignment detection systems are used to detect magnetic alignment and/or coil alignment (e.g., via Hall sensors, magnetometer, coil impedance monitoring, or other sensing), and the controller adjusts operation accordingly (e.g., to reduce heating, improve efficiency, compensate for positional variation, or prompt the user).

Lighting architectures and control. In one embodiment, the multifunction mobile device mount includes a light module comprising one or more light sources positioned to illuminate a scene within a field of view of a camera of the mobile electronic device. In one embodiment, the light module is positioned relative to the magnetic coupling structure and the wireless charging transmitter so that, when the mobile electronic device is held in a charging position, the light module occupies a predetermined illumination position relative to a front-facing or rear-facing camera of the mobile electronic device. In one embodiment, the light module comprises an annular light arranged around a central opening.

In one embodiment, the light module includes a diffuser, reflector, or optical mixing element to provide more uniform illumination. In one embodiment, the diffuser is removable and replaceable, and the light module may accept removable diffusion plates and/or filter plates (e.g., color filters, neutral density, warming/cooling filters).

In one embodiment, the light module includes one or more user controls to adjust illumination parameters. For example, the mount may include one or more capacitive touch controls, buttons, or sliders to adjust light intensity (brightness), such as by cycling through discrete intensity levels and/or providing continuous dimming. In certain embodiments, intensity control is implemented by pulse-width modulation (PWM) and/or by varying a drive current supplied to one or more light emitters.

In one embodiment, the light module includes a first set of light emitters configured to provide a warm output and a second set of light emitters configured to provide a cool output, permitting a user to adjust a relative contribution of the warm output and the cool output (i.e., adjust color temperature), optionally independent of intensity adjustment.

In one embodiment, the light module further comprises multi-color illumination including RGB emitters and/or multi-channel emitters configured to provide selectable colors and/or selectable correlated color temperatures.

In one embodiment, the light module comprises an edge-lit panel configuration (e.g., a light guide plate coupled to one or more edge emitters) and/or a rear-facing fill light configured to illuminate a user or a background from a rear side of the mount.

In one embodiment, the light module includes a driver architecture configured to reduce flicker (e.g., high-frequency PWM above a threshold suitable for video capture, constant-current regulation, and/or hybrid regulation), thereby enabling video-friendly operation. In one embodiment, the device includes thermal management features (e.g., heat spreaders, thermally conductive housing regions, thermal sensors, graphite sheets, metallic internal frames, heat sinks, phase-change elements, and/or control-based thermal derating) to support high-lumen operation and to manage heat generated by the wireless charging transmitter, internal power source, light module, and associated power electronics.

Portability and deployment modes. In one embodiment, the housing is configured for pocket-sized or portable carry, enabling rapid deployment without assembling separate tripod legs or external lighting accessories.

In one embodiment, the housing includes a deployable kickstand configured to support the mount on a horizontal surface such as a desk or table. The kickstand may support one or more viewing angles and may include a rigid backing or stopper to limit travel and/or reinforce a deployed position.

In one embodiment, the device further includes an integrated fold-out tripod architecture comprising two or more deployable legs configured to define a three-point support with the housing, or three deployable legs configured for tripod support. In one embodiment, the legs are telescoping and retract into the housing in a stored configuration. In one embodiment, the tripod architecture is implemented as a detachable tripod module that couples to the housing via a modular interface.

In one embodiment, the device supports standalone operation modes independent of coupling to a phone, including use as a portable reading light, night light, emergency light, and/or desk lamp configuration. In one embodiment, the controller provides an emergency mode that prioritizes illumination and/or provides predefined output patterns.

Multi-surface attachment and mounting ecosystem expansion. In one embodiment, the mount includes a multi-surface adhesive attachment member coupled to the rear face of the housing. The multi-surface adhesive attachment member is configured to allow the mount to be releasably attached to vertical or inclined surfaces, including porous and non-porous surfaces.

In one embodiment, the adhesive attachment member is reusable and removable and is configured for repeated attachment and removal cycles while maintaining sufficient holding force for typical mobile imaging use cases.

In one embodiment, the adhesive attachment member is configured for clean removal and to leave no residue or substantially no residue on typical mounting surfaces. In one embodiment, the adhesive attachment member is washable or cleanable to restore tack.

In one embodiment, the adhesive attachment member comprises a reusable adhesive tape, gel pad, elastomeric adhesive, microstructured adhesive, gecko-inspired adhesive, hybrid micro-suction/adhesive material, or combinations thereof.

In one embodiment, the adhesive attachment member is replaceable and is retained by a slot, recess, carrier, cassette, or frame formed in the housing. A peel corner, pull tab, or removable liner may be included to facilitate handling and replacement.

In one embodiment, the device supports a mounting ecosystem with interchangeable mounting adapters. For example, the rear face may include a docking interface (e.g., mechanical latch, rails, magnets, and/or electrical contacts) configured to removably couple to a suction-based mount, a hybrid suction-and-adhesive mount, a mechanical clamp attachment, a magnetic wall plate docking system, a vehicle vent adapter, and/or a desk or studio docking cradle. The docking interface may permit rapid swap between mounting modes while maintaining a common core platform.

Hinge, detents, and rotational / multi-axis articulation. In one embodiment, the mount includes a hinge coupling a first housing portion to a second housing portion. The first housing portion may include the light module, and the second housing portion may include the internal power source and the wireless charging transmitter. The hinge may permit folding between a compact configuration and one or more deployed configurations, including configurations in which a ring or annular light is folded relative to the second housing portion.

In one embodiment, the hinge includes one or more magnets arranged to provide a snap action, detent, or stable positioning at one or more hinge angles.

In one embodiment, in addition to or in lieu of the hinge, the device includes a rotational interface configured to permit relative rotation between the mounting plane (e.g., defined by the adhesive attachment member or mounting adapter) and the device plane (e.g., defined by the magnetic coupling structure and/or front face). The rotational interface may provide 360-degree rotation and may be implemented by a bearing, swivel ring, bushing, ball joint, or similar mechanism.

In one embodiment, the rotational interface includes an indexed detent, detent ring, ratchet, or stop positions to provide repeatable angular positioning. In one embodiment, the rotational interface includes a lock (e.g., a cam lock, friction lock, clutch, or lever) configured to selectively resist or prevent rotation.

In one embodiment, the articulation is multi-axis and permits at least two degrees of rotational freedom (e.g., via a ball joint), optionally with a lockable or friction-held positioning.

Protective / reinforcement features and handheld retention. In one embodiment, the housing includes protective features such as shock-absorbing regions, resilient overmold portions, reinforced perimeter structures, and/or multi-layer construction configured to disperse impact energy. In one embodiment, a protective shell or bumper is replaceable (e.g., as a removable perimeter shell) and may be configured to improve grip. In one embodiment, the housing, protective shell, hinge components, support structures, and other structural members are formed from one or more materials selected from polymers, elastomers, metals, alloys, composites, fiber-reinforced materials, ceramics, glass-filled materials, or combinations thereof, and no embodiment is limited to a particular material selection unless expressly recited.

In one embodiment, the protective shell has a distinctive grip geometry, including ridges, contours, elastomeric textures, finger rests, or other grip-enhancing features intended to improve handling during handheld use (e.g., while walking). In one embodiment, the device is thinner overall than a prior configuration by rearranging internal component stacking (e.g., battery, charging coil, light driver, and/or heat spreading elements) while maintaining function.

In one embodiment, the device includes a hand strap, retention strap, lanyard, or wrist strap coupled to the housing and configured to support a user's hand and reduce the likelihood of dropping the device. The strap may be adjustable, removable, and/or anchored at one or more strap attachment points integrated into the housing and/or protective shell.

Smart connectivity and sensing. In one embodiment, the device includes a controller configured to control light output, charging functions, and user interface functions, including indicator outputs configured to indicate charging status, battery state, power state, and/or wireless charging enablement.

In one embodiment, the device includes a wireless communication interface (e.g., Bluetooth/BLE) configured to communicate with the coupled mobile electronic device and/or with a companion application. The companion application may provide control of light modes, brightness, color temperature, RGB settings, charging enablement, and/or presets.

In one embodiment, the device supports firmware updates (e.g., over-the-air updates via a mobile application or via a wired port).

In one embodiment, the device includes one or more sensors (e.g., ambient light sensor, proximity sensor, accelerometer, temperature sensor) and is configured to automatically adjust brightness and/or color parameters based on sensor input. In one embodiment, the device supports gesture control (e.g., detecting a hand wave to toggle lighting or adjust brightness). In one embodiment, the device coordinates with imaging features such as face-tracking or exposure settings of the mobile device (e.g., via application-level integration).

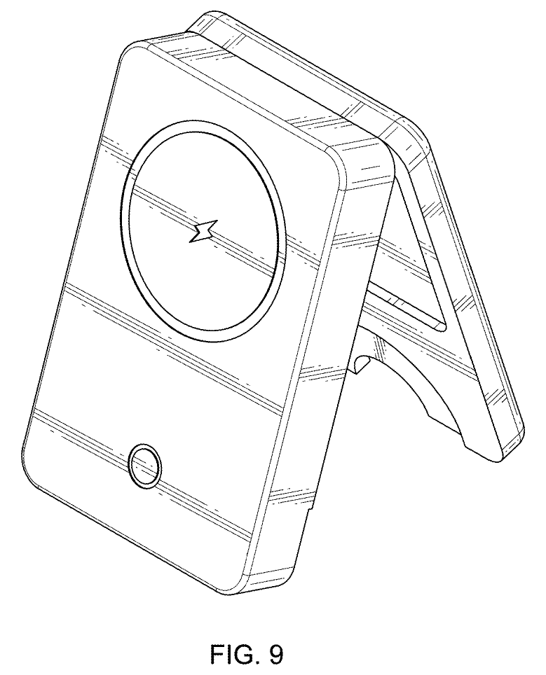

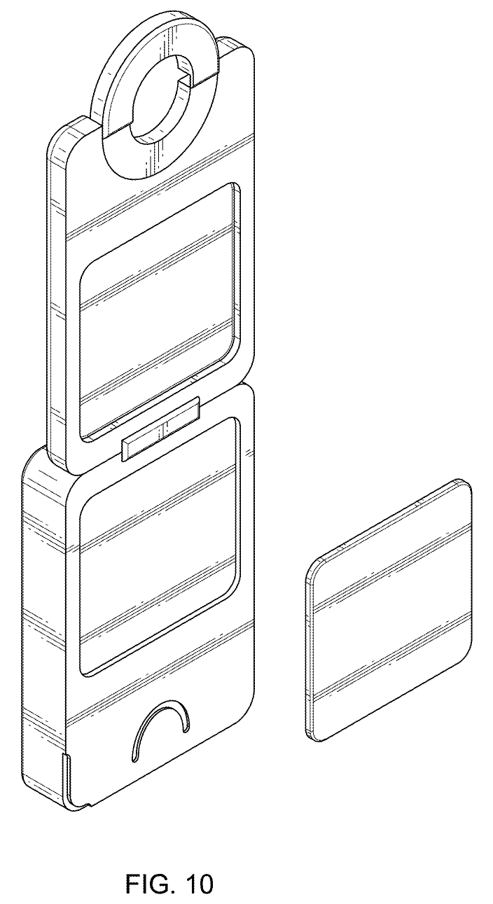

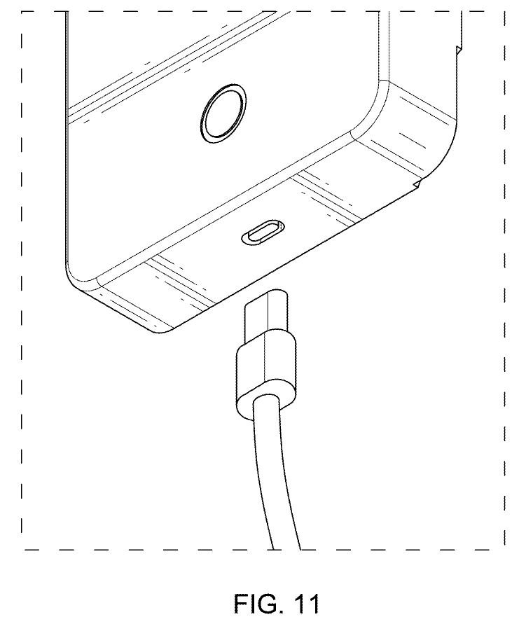

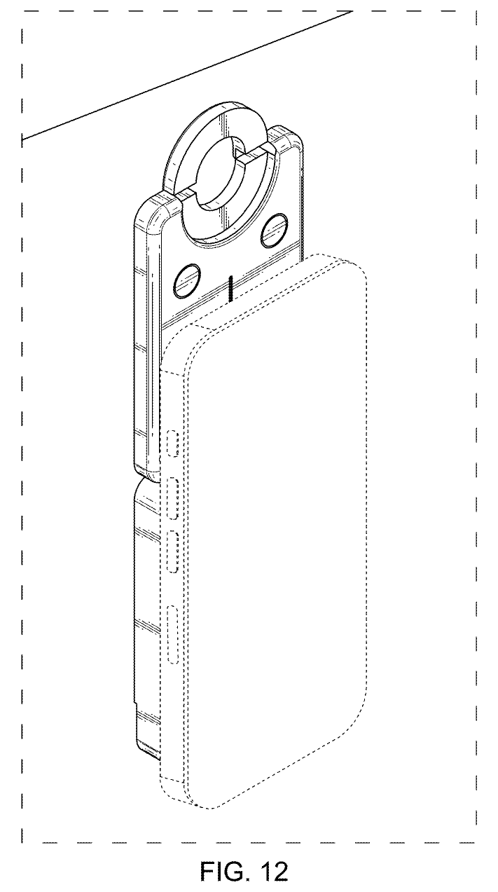

Example use cases. In an example use case (see FIG. 9), a user attaches the mount to a wall, cabinet, mirror, or other surface using the multi-surface adhesive attachment member, magnetically couples the phone to the front face, activates the light module, optionally adjusts light intensity (brightness) and/or color temperature (and/or RGB), and wirelessly charges the phone during camera use.

In another example use case, the user deploys the kickstand and/or integrated tripod legs to support the mount on a desk for video calls or recording while receiving illumination and wireless charging.

In another example use case, the user uses the device in a handheld mode while walking, optionally with the protective shell and/or hand strap improving grip and retention, while the phone is magnetically coupled and optionally rotatable about a rotation interface.

The embodiments described herein are illustrative and not limiting. Individual features from different embodiments may be combined.

What is claimed is:

1. A multifunction mobile device mount, comprising:
a housing having a front face and a rear face;
a magnetic coupling structure at the front face configured to removably couple to a mobile electronic device;
a wireless charging transmitter disposed to wirelessly transmit power to the mobile electronic device while the mobile electronic device is coupled to the magnetic coupling structure;
a light module carried by the housing, the light module including at least one light source configured to illuminate a scene for imaging by a camera of the mobile electronic device; and
a reusable adhesive attachment member coupled to the rear face, the reusable adhesive attachment member configured to releasably adhere the housing to each of (i) a porous surface and (ii) a non-porous surface.

2. The multifunction mobile device mount of claim 1, further comprising a rechargeable internal power source disposed within the housing and electrically coupled to power the wireless charging transmitter and the light module.

3. The multifunction mobile device mount of claim 2, further comprising a port configured to receive external power to charge the rechargeable internal power source, wherein the port is further configured to output power to an external device.

4. The multifunction mobile device mount of claim 1, further comprising a rotational interface configured to permit relative rotation between (i) a mounting plane defined by the reusable adhesive attachment member and (ii) a device plane defined by the magnetic coupling structure.

5. The multifunction mobile device mount of claim 4, wherein the rotational interface provides indexed detent rotation and further includes a lock configured to selectively resist or prevent rotation.

6. The multifunction mobile device mount of claim 1, wherein the reusable adhesive attachment member is removable and replaceable, and wherein the housing includes a recess, slot, carrier, or cassette configured to retain the reusable adhesive attachment member, the reusable adhesive attachment member including a peel corner, pull tab, or removable liner configured to facilitate removal.

7. The multifunction mobile device mount of claim 1, wherein the reusable adhesive attachment member is configured to be removed without leaving residue or without leaving substantial residue and is washable or cleanable to restore tack, and wherein the reusable adhesive attachment member comprises at least one of a gel adhesive, an elastomeric adhesive, a microstructured adhesive, a gecko-inspired adhesive surface, or a hybrid micro-suction/adhesive material.

8. The multifunction mobile device mount of claim 1, further comprising a removable mounting adapter configured to couple to the housing and configured to couple the housing to a surface, the removable mounting adapter comprising at least one of a suction attachment, a hybrid suction-and-adhesive attachment, a mechanical clamp attachment, a magnetic wall plate docking interface, a vehicle vent adapter, or a docking cradle.

9. The multifunction mobile device mount of claim 1, further comprising a protective shell carried by the housing, the protective shell including a shock-absorbing perimeter and a grip-enhancing geometry.

10. The multifunction mobile device mount of claim 1, further comprising a hand strap coupled to the housing and configured to retain the multifunction mobile device mount on a user's hand during handheld use.

11. The multifunction mobile device mount of claim 1, wherein the light module comprises an annular light surrounding a central opening.

12. The multifunction mobile device mount of claim 11, wherein the annular light includes a diffuser, and wherein at least one of the diffuser or a filter plate is removable.

13. The multifunction mobile device mount of claim 1, wherein the light module includes a user control configured to adjust at least one of a light intensity or a color parameter, the color parameter including at least one of a color temperature or an RGB color output.

14. The multifunction mobile device mount of claim 1, wherein the magnetic coupling structure comprises a magnet array configured to align the mobile electronic device relative to the wireless charging transmitter.

15. A multifunction mobile device mount, comprising:
a first housing portion carrying an annular light;
a second housing portion carrying a magnetic coupling structure configured to removably couple to a mobile electronic device and carrying a wireless charging transmitter configured to wirelessly transmit power to the mobile electronic device while the mobile electronic device is coupled to the magnetic coupling structure;
a hinge coupling the first housing portion to the second housing portion;
a rechargeable internal power source disposed within the second housing portion and electrically coupled to power the wireless charging transmitter and the annular light; and
a reusable adhesive attachment member coupled to a rear face of the second housing portion, the reusable adhesive attachment member configured to releasably adhere the multifunction mobile device mount to each of (i) a porous surface and (ii) a non-porous surface, wherein the hinge includes at least one magnetic detent configured to stabilize the first housing portion relative to the second housing portion at a predetermined hinge angle.

16. The multifunction mobile device mount of claim 15, wherein the hinge includes at least one magnet pair configured to provide a snap action at the predetermined hinge angle.

17. The multifunction mobile device mount of claim 15, further comprising a deployable support structure comprising at least one of a kickstand or integrated tripod legs.

18. The multifunction mobile device mount of claim 15, wherein the second housing portion comprises a modular interface configured to removably couple at least one interchangeable module selected from a light module, a battery module, a wireless charging module, or an accessory attachment module.

19. A method of using a multifunction mobile device mount, comprising:
releasably attaching a housing of the multifunction mobile device mount to a surface using a reusable adhesive attachment member coupled to the housing, wherein the surface comprises a porous surface or a non-porous surface;
removably coupling a mobile electronic device to a front face of the housing using a magnetic coupling structure;
activating a light module carried by the housing to illuminate a scene for imaging by a camera of the mobile electronic device; and
wirelessly transmitting power from a wireless charging transmitter of the multifunction mobile device mount to the mobile electronic device while the mobile electronic device is coupled to the front face.

20. The method of claim 19, further comprising at least one of: (i) rotating the mobile electronic device relative to the surface using a rotational interface of the multifunction mobile device mount and locking the rotation at a selected orientation, (ii) deploying a kickstand or integrated tripod legs to support the multifunction mobile device mount on a horizontal surface, or (iii) cleaning the reusable adhesive attachment member to restore tack and reattaching the housing to the surface.
